(19) United States
(12) Patent Application Publication
(10) Pub. No.: US 2024/0115980 A1
(43) Pub. Date: Apr. 11, 2024

(54) CAPSULE TYPE BIDET FILTER

(71) Applicant: Bian Co.,Ltd., Sejong-si (KR)

(72) Inventor: Jae Geun Jeong, Sejong-si (KR)

(21) Appl. No.: 18/470,448

(22) Filed: Sep. 20, 2023

(30) Foreign Application Priority Data
Oct. 5, 2022 (KR) 10-2022-0127057

(51) Int. Cl. B01D 35/30; B01D 29/33; C02F 1/00; C02F 1/68; E03D 9/08

(52) U.S. Cl. CPC B01D 35/30; B01D 29/33; C02F 1/001; C02F 1/68; E03D 9/08; C02F 2103/02

(57) ABSTRACT

A capsule type bidet filter includes an outer body 110 configured in such a shape that a diameter thereof gradually increases as it goes from upper to lower position, with a lower end being open and connected to a water supply pipe so as to supply raw water, an inner body 210 that is coupled inside the outer body 110, is configured to filter and purify the raw water as it flows in, and discharges the filtered and purified raw water toward a raw water discharge pipe; and a finishing member 140 coupled to the open lower end of the outer body 110. in which the capsule type bidet filter is coupled inside a bidet controller so that the capsule type bidet filter is not exposed to outside.

### CROSS-REFERENCE TO RELATED APPLICATION

The present application is based upon and claims the benefit of priority to Korean Patent Application No. 10-2022-0127057, filed on Oct. 5, 2022, the disclosure of which is hereby incorporated by reference herein in its entirety.

### TECHNICAL FIELD

The present disclosure relates to a capsule type bidet filter, and more specifically, to a capsule type bidet filter that can be manufactured at reasonable cost, is easy and simple to install, thus improving consumer satisfaction, and can also be manufactured into a compact size so as to be installed inside the bidet's controller.

### BACKGROUND

In general, a bidet refers to a device used for bathing the external genitals and the anal region after using the toilet, and it is a device that sprays hot water with an appropriate temperature from the center of the device to gently clean the area to be cleaned without requiring user to use hands after using the toilet. Regarding the water used in the bidet for cleaning the human body, part of the water is supplied from an external water pipe to a water storage tank for cleaning the toilet, and the other part is supplied directly to the nozzle of the bidet for cleaning the human body.

This bidet purifies raw water for human body cleansing and supplies the purified water to the nozzle, and for this purpose, it is configured to be equipped with a separate bidet filter.

For example, Korean Patent No. 10-1483526 discloses a bidet filter assembly including a filter body having an opening formed in one side through which raw water flows in and out, a base that accommodates a filter member that filters the inflowing raw water, in which the base is fastened to the filter body, a filter cap that guides the raw water flowing into the filter body to the filter member, and a mesh part disposed in a space between the filter body and the filter member, the mesh part filtering the filtered raw water flowing out through the space, in which the raw water flows into the filter member, passes through the filter member, moves along between the filter body and the filter member, and then passes through the mesh part.

However, according to Korean Patent No. 10-1483526 described above, since the bidet filter has a long cylindrical shape, it is kept in an exposed state when combined to a separate holder provided in the bidet controller, and accordingly, there is a problem in that structural improvement of the bidet controller or the holder connected to the water supply pipe is very limited.

However, according to Korean Patent No. 10-1483526 described above, since the bidet filter is formed of a certain size or more, the manufacturing cost increases, and this inevitably leads to an increase in the cost of bidet filters, which is a factor that reduces consumers' purchase desire and satisfaction.

It is to be noted that the background or related art described above is only for helping to understand the technical meaning of the present disclosure, and does not mean a technique widely known in the technical field to which the present disclosure pertains before the application of the present disclosure.

### SUMMARY

In order to solve one or more problems (e.g., the problems described above and/or other problems not explicitly described herein), an object of the present disclosure is to provide a capsule type bidet filter that can be manufactured at a low cost and can be easily and simply installed, thereby improving consumer satisfaction.

In addition, an object of the present disclosure is to provide a capsule type bidet filter that can be compactly manufactured so as to be installed in the bidet's controller, which enables various design changes and improvements in the filter detachment device that is connected to the bidet controller and the water supply pipe and equipped with the bidet filter.

It should be understood, however, that the scope of the present disclosure is not limited to the above and that the objects and effects which can be understood from the solution means and the embodiments of the present disclosure are also included therein even if not explicitly mentioned.

According to an embodiment of the present disclosure for achieving the above object, the disclosure may include an outer body 110 configured in such a shape that a diameter thereof gradually increases as it goes from upper to lower position, with a lower end being open and connected to a water supply pipe so as to supply raw water, an inner body 210 that is coupled inside the outer body 110, is configured to filter and purify the raw water as it flows in, and discharges the filtered and purified raw water toward a raw water discharge pipe, and a finishing member 140 coupled to the open lower end of the outer body 110.

According to an embodiment, the outer body 110 may include a filter mounting part 120 that is extended upwardly from an upper central portion, is detachably coupled to a filter detachment device so as to be connected to the water supply pipe, and includes a raw water supply hole 122 through which raw water is supplied, a coupling hole 118 formed at a center of a bottom surface of the filter mounting part 120 and with which the inner body 210 is coupled, a raw water moving part 116 configured in such a shape that an area thereof gradually increases as it goes downward, and allowing the supplied raw water to move to a lower surface of the inner body 210, and a finishing flange 112 formed on a circumferential surface of a lower end and to which the finishing member 140 is joined.

According to an embodiment, the outer body 110 may further include a raw water guiding part 114 formed at an upper end of the raw water moving part 116 and guiding the supplied raw water to move toward the raw water moving part 116.

According to an embodiment, the inner body 210 may include a connection flange 220 connected to the raw water discharge pipe and including a raw water outlet hole 214 formed at a center of the bottom surface, through which the filtered and purified raw water flows out, a raw water purification part 212 formed on an inner surface of the inner body 210, through which the filtered and purified raw water flows in, and guiding the inflowing raw water to move upward toward the raw water outlet hole 214, and a plurality of ceramic balls provided in the raw water purification part 212 and providing an oriental medicine therapy or aroma therapy functions to the raw water.

According to an embodiment, the inner body 210 may further include a filtration filter 230 coupled to a lower end of the raw water purification part 212, filtering and purifying the raw water supplied to the outer body 110, and introducing the filtered and purified raw water into the raw water purification part 212.

According to an embodiment, the inner body 210 may further include a filtration filter 230 coupled to an outer circumferential surface, filtering and purifying the raw water supplied to the outer body 110, and introducing the filtered and purified raw water into the raw water purification part 212.

According to an embodiment, the outer body 110 may further include an opening and closing member 310 rotatably coupled to and opening and closing the open lower end.

According to an embodiment, the inner body 110 may further include an inner cap 320 detachably coupled to the open lower surface of the inner body 210 and including a plurality of inlet holes formed to allow the supplied raw water to flow into the inner body 210.

According to an embodiment, the inner body 210 may further include a filtration filter 230 coupled to either the lower surface or an outer circumferential surface and filtering and purifying the supplied raw water.

According to an embodiment, the inner body 210 may further include a filter fixing part 330 bent from a lower end toward a center and supporting fixation and separation of the filtration filter 230, and a support rib 340 formed at a lower end of the filter fixing part 330 and spaced away by a predetermined distance along a circumferential surface based on a center of the inner body 210, and to which the finishing member 140 is joined.

According to an embodiment, the capsule type bidet filter is coupled inside the bidet controller so that the capsule type bidet filter is not exposed to the outside.

According to the embodiments, it is possible to manufacture the filter at a low cost and it is also easy and simple to install the same, which has the effect of improving consumer satisfaction.

According to the embodiments, the bidet filter can be compactly manufactured so as to be installed in the bidet's controller, which enables various design changes and improvements in the filter detachment device that is connected to the bidet controller and the water supply pipe and equipped with the bidet filter.

Further, the various and beneficial advantages and effects of the present disclosure are not limited to the above description, and can be more easily understood in the course of describing a specific embodiment of the present disclosure.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a perspective view of a capsule type bidet filter according to a first embodiment;

FIG. 2 is a cross-sectional view of the capsule type bidet filter according to the first embodiment;

FIG. 3 is a view schematically showing an installation state of a filtration filter of the capsule type bidet filter according to another first embodiment;

FIG. 4 is a view showing a reusable capsule type bidet filter according to a second embodiment;

FIG. 5 is a view showing a reusable capsule type bidet filter according to another second embodiment;

FIG. 6 is a view showing a capsule type bidet filter according to a third embodiment; and

FIG. 7 is a view schematically showing a capsule type bidet filter according to the present disclosure installed on a filter detachment device.

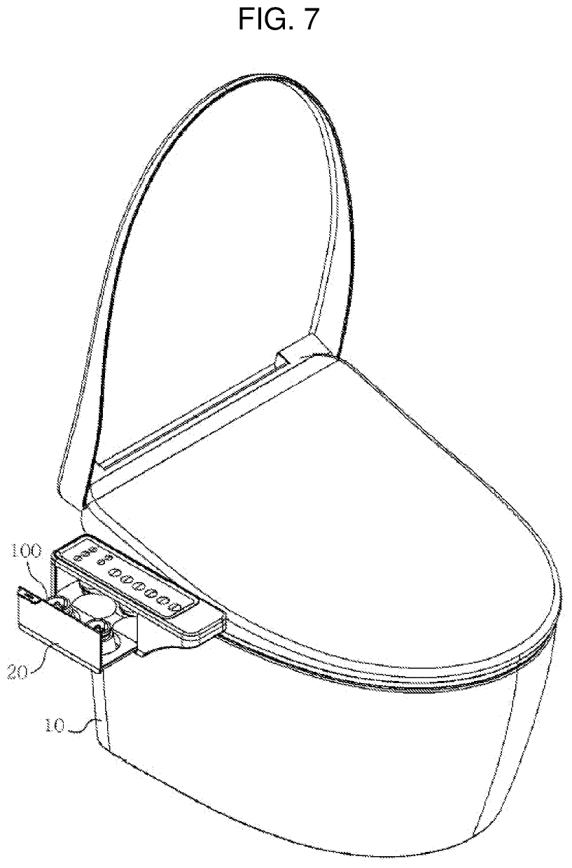

### DETAILED DESCRIPTION

Hereinafter, preferred embodiments of the present disclosure will be described in detail with reference to the accompanying drawings. It should be noted that, when adding reference numerals to the components shown in the drawings, the same components, whether they are illustrated in the same drawing or different drawings, will be denoted by the same reference numerals. In the following description of the present disclosure, a detailed description of known functions and configurations incorporated herein will be omitted when it may make the subject matter of the present disclosure rather unclear.

In addition, it is to be understood that, unless specifically stated to the contrary, the term “comprise”, “include”, or “have” as used herein may mean that a corresponding component can be inherently included, and therefore, should be construed as meaning that other components may be additionally included rather than excluding the same, and all terms including technical or scientific terms have the same meaning as commonly understood by one of ordinary skill in the art to which this disclosure belongs, unless otherwise defined. Further, in the description of the components of the present disclosure, “first,” “second,” “A,” “B,” “(a),” “(b)” may be used to identify the components. These are used to distinguish a component from another component, and used only for convenience of explanation, and the nature, sequence, or order of the corresponding component is not limited by these expressions. When a certain component is stated as being “connected” or “coupled” to another component, it is to be understood that there may be yet another intervening component “connected” or “coupled between the two components, although the two components may also be directly connected or coupled to each other.

Hereinafter, embodiments of the present invention will be described in detail with reference to the accompanying drawings.

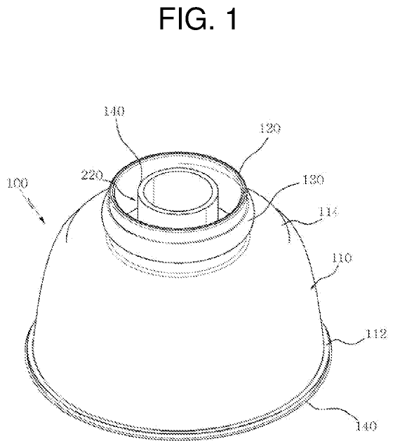

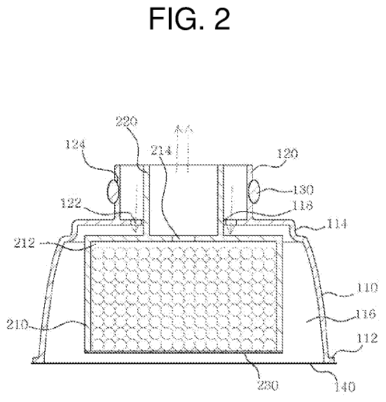

As shown, a capsule type bidet filter 100 of the present disclosure is detachably coupled to a filter detachment device configured in a bidet controller, as shown in FIGS. 1 and 2, and is configured to be coupled inside the bidet controller when coupled to the filter detachment device such that the bidet filter is not exposed to the outside, in which the capsule type bidet filter 100 includes an outer body 110 connected to a water supply pipe and to which raw water is supplied, and an inner body 210 formed inside the outer body 110 to filter and purify the supplied raw water, and to deliver the purified raw water, which is purified by a contact with ceramic balls containing an aroma component and thus contains the aroma component, to a nozzle side.

The outer body 110 is formed in a circular shape and in such a shape that its diameter gradually increases from upper to lower position, is configured such that a lower end is open to allow coupling with the inner body 210, and includes a coupling hole 118 through which the inner body 210 is coupled through an upper central portion, and a filter mounting part 120 detachably connected to a water supply pipe at its upper end and formed such that raw water supplied from the water supply pipe can be supplied into the interior of the outer body 110.

When raw water is supplied with the open lower end of the outer body 110 being closed, a finishing member 140 that guides the raw water to flow into the inner body 210 is joined to the outer body 110.

In this case, the finishing member 140 may be a typical packaging film, although embodiments are not limited thereto.

That is, in the present disclosure, the outer body 110 may be manufactured with its lower end open to allow easy detachment from and attachment to the inner body 210, and also to allow convenient replacement of the ceramic balls provided in the inner body 210, and after the outer body 110 is coupled with the inner body 210, the finishing member 140 is joined to the outer body 110 to close the interior of the outer body 110 and also prevent raw water from leaking out.

In this case, a finishing flange 112 configured to enable connection with the finishing member 140 is formed on the outer body 110 along the circumferential surface of the lower end such that the finishing member 140 can be joined thereto.

In an example, the finishing flange 112 may be configured with an adhesive applied thereto for easier joining of the finishing member 140, although embodiments are not limited thereto.

In addition, the outer body 110 includes a raw water moving part 116 which is configured as an internal space, and which allows the supplied raw water to move to the lower surface of the inner body 210, and guides the moved raw water so that it can flow into the inner body 210.

The raw water moving part 116 may be configured in such a shape that its area gradually increases as it goes downward such that the flow rate gradually slows down as it moves towards the lower end of the outer body 110, thereby preventing the finishing member 140 from being arbitrarily separated from the finishing flange 112 by the flow rate of raw water moving downward.

In addition, the outer body 110 may further include a raw water guiding part 114 which is formed on an upper circumferential surface and which guides the supplied raw water to move toward the raw water moving part 116.

In an example, the raw water guiding part 114 is formed to be bent toward the center of the outer body 110, with its end having a predetermined arc to have a diameter smaller than the diameter of the raw water moving part 116, and is formed to extend from the upper end of the raw water moving part 116.

Meanwhile, the filter mounting part 120 is formed to extend upward from the upper central portion, is detachably coupled to the filter detachment device to be connected to the water supply pipe to supply raw water, is formed integrally with the outer body 110, and includes a raw water supply hole 122 formed through it to supply raw water from the water supply pipe.

The raw water supply hole 122 is formed through the upper central part of the outer body 110, and preferably includes a plurality of holes spaced apart at predetermined intervals along the circumferential surface with respect to the axial center of the outer body 110.

In addition, the filter mounting part 120 includes a sealing groove 124 formed along an outer circumferential surface into which a sealing member 130 is coupled to prevent the outflow of raw water supplied from the water supply pipe when coupled with the filter detachment device and the water supply pipe.

The filter mounting part 120 may preferably be configured to be separated from and coupled to the filter detachment device in a one-touch manner, but embodiments are not limited thereto, and the filter mounting part 120 may be coupled by a screw coupling method, and can be easily coupled to and detached from the filter detachment device provided in the existing bidet controller.

The inner body 210 is coupled inside the outer body 110, with its upper end being coupled to the filter detachment device and also connected to the raw water discharge pipe connected to the nozzle, and it is a component configured to allow the inflow of supplied raw water, filter and purify the inflowing raw water, and discharge the water to the raw water discharge pipe.

This inner body 210 includes a connection flange 220 formed to extend upward to the upper central portion and connected to the raw water discharge pipe to allow the filtered and purified raw water to flow into the raw water discharge pipe.

In addition, the inner body 210 includes a raw water outflow hole 214 formed through the central portion of the lower end of the connection flange 220 and allowing the filtered and purified raw water to flow out.

In addition, the inner body 210 includes a raw water purification part 212 containing ceramic balls therein, guides the inflowing raw water to move upward while contacting the ceramic balls, and allows the upwardly moving raw water to flow out through the raw water outflow hole 214.

In an example, the ceramic ball is a mixture of natural aromatic materials that provide oriental medicine therapy or aromatherapy functions at a certain weight ratio, and it provides the beneficial components of natural fragrance materials while in contact with raw water.

In addition, in the present disclosure, the inner body 210 is provided with a filtration filter 230 that filters and purifies the raw water supplied to the outer body 110 when the raw water flows into the inner body 210.

The filtration filter 230 is detachably coupled to the open lower surface of the inner body 210 such that filtration and purification of raw water can be performed from the lower surface.

Although it is described above that the inner body 210 of the present disclosure configured as described above has the filtration filter 230 coupled to the lower surface, embodiments are not limited thereto.

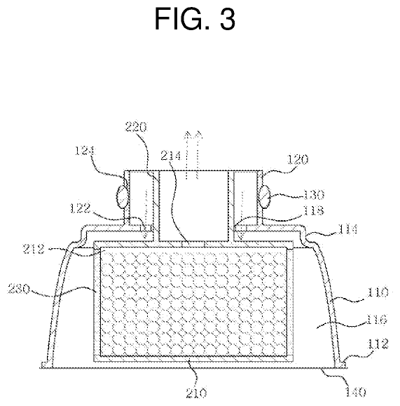

That is, the filtration filter 230 of the present disclosure may be configured to be detachably coupled or joined along the circumferential surface of the inner body 210, as shown in FIG. 3. When the filtration filter 230 is configured on the circumferential surface of the inner body 210, it is preferable that the lower surface is configured in a closed state.

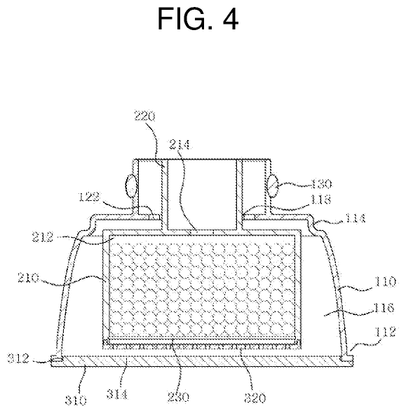

Meanwhile, as shown in FIG. 4, the capsule type bidet filter 100 of the present disclosure may be configured on the open lower surfaces of each of the outer body 110 and the inner body 210, and may further include an opening and closing member 310 and an inner cap 320 for opening and closing each of the open lower surfaces.

The opening and closing member 310 closes or opens the open lower surface of the outer body 110, prevents the finishing member 140 from being arbitrarily separated due to the flow rate or weight of the raw water when raw water is supplied, and is rotatably coupled to the finishing flange 112 of the outer body 110.

The opening and closing member 310 and the finishing flange 112 may each include a rotating flange, and be configured such that a rotation pin is inserted into the rotation flange so that the opening and closing member 310 is rotated from from the finishing flange 112.

However, embodiments are not limited to the above, and in another configuration, corresponding threads may be formed on the inner surface of the finishing flange 112 and on the upper outer peripheral surface of the opening and closing member 310, respectively, such that the coupling may be performed by a screw coupling method.

The opening and closing member 310 includes a sealing block 314 inserted into the lower surface of the outer body 110 so as to maximize the sealing force on the open lower surface of the outer body 110, and is configured such that an elastic ring 312 made of rubber is mounted on the outer peripheral surface of the sealing block 314.

Meanwhile, according to the present disclosure, when the opening and closing member 310 is configured in the outer body 110, the finishing member 140 may be configured selectively, and since repeated opening and closing operations of the opening and closing member 310 are possible, the capsule type bidet filter 100 can be easily reused.

That is, when the finishing member 140 singly seals the lower end of the outer body 110, in order to replace the ceramic ball or the filtration filter 230, it is necessary to perform a process of removing the used finishing member 140 and rejoining with a new finishing member 140, but when the opening and closing member 310 is provided, it will be possible to easily and conveniently reuse the finishing member 140 without rejoining the finishing member 140 after replacing the ceramic ball or the filtration filter 230.

In addition, the inner cap 320 is detachably coupled to the open lower surface of the inner body 210 and includes a plurality of inlet holes formed to allow the supplied raw water to flow into the inner body 210.

This inner cap 320 may be detachably coupled to the inner body 210 by either a fitting method or a screw coupling method, although embodiments are not limited thereto.

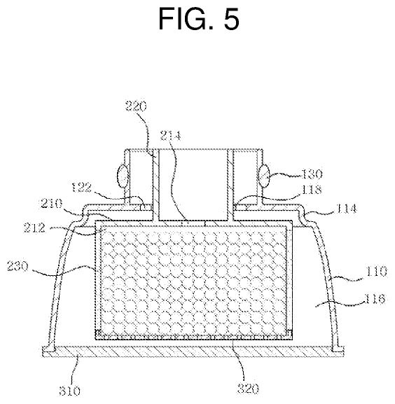

In addition, even when the inner cap 320 described above is provided, the filtration filter 230 formed in the inner body 210 of the present disclosure may be formed on the lower surface or the circumferential surface of the inner body 210 as shown in FIGS. 4 and 5.

Although the inner body 210 of the present disclosure configured as described above has been described as being coupled to the through hole 118 formed in the upper central portion of the outer body 110, embodiments are not limited thereto, and the inner body 210 may be integrally formed by being molded together upon molding the the outer body 110.

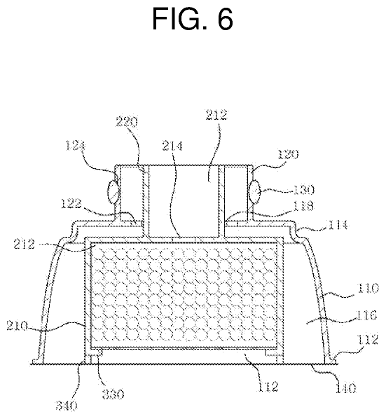

Meanwhile, as shown in FIG. 6, when the inner body 210 of the present disclosure includes the filtration filter 230 formed at the bottom, the inner body 210 may further include a filter fixing part 330 that supports the filtration filter 230 so that the filtration filter 230 without a separate fixing means can be stably fixed and separated.

In this case, the filter fixing part 330 may be configured in the form of a flange that is bent from the lower end of the inner body 210 toward the center, or may be configured in the form of a protrusion or rib.

In addition, when the inner body 210 includes the filter fixing part 330 formed therein, the inner body 210 may further include a support rib 340 that is formed at a lower end of the filter fixing part 330 and is spaced at a predetermined distance along the circumferential surface with respect to the center of the inner body 210 to allow smooth inflow of raw water and is joined to the finishing member 140 to improve the bonding force between the finishing member 140 and the capsule type bidet filter 100.

Meanwhile, reference numerals “10” and “20” not described in the detailed description of the present disclosure indicate a bidet and a filter detachment device, respectively.

The above description is merely illustrative of the technical idea of the present invention, and those of ordinary skill in the art to which the present invention pertains will be able to make various modifications and variations without departing from the essential characteristics of the present invention. Accordingly, the embodiments disclosed in the present invention are not intended to limit the technical idea of the present invention, but to explain the technical idea, and the scope of the technical idea of the present invention is not limited by these embodiments. The scope of protection of the present invention should be interpreted by the following claims, and all technical ideas within the scope equivalent thereto should be construed as being included in the scope of the present invention.

1. A capsule type bidet filter comprising:
an outer body configured in such a shape that a diameter thereof gradually increases as it goes from upper to lower position, with a lower end being open and connected to a water supply pipe so as to supply raw water;
an inner body that is coupled inside the outer body, is configured to filter and purify the raw water as it flows in, and discharges the filtered and purified raw water toward a raw water discharge pipe; and
a finishing member coupled to the open lower end of the outer body and sealing the open lower end after the inner body is coupled to the outer body,
wherein the outer body includes:
a filter mounting part that is extended upwardly from an upper central portion, is detachably coupled to a filter detachment device so as to be connected to the water supply pipe, and includes a raw water supply hole through which raw water is supplied;
a coupling hole formed at a center of a bottom surface of the filter mounting part and with which the inner body is coupled;
a raw water moving part configured in such a shape that an area thereof gradually increases as it goes downward and configured to allow the supplied raw water to move to a lower surface of the inner body such that a flow rate of the raw water gradually slows down as the raw water moves towards the lower end of the outer body, thereby preventing the finishing member from being arbitrarily separated from the finishing flange by the flow rate of raw water moving downward; and
a finishing flange formed on a circumferential surface of a lower end and in which an adhesive is applied to join the finishing member thereto.

2. (canceled)

3. The capsule type bidet filter according to claim 1, wherein the outer body further includes a raw water guiding part formed at an upper end of the raw water moving part and guiding the supplied raw water to move toward the raw water moving part.

4. The capsule type bidet filter according to claim 1, wherein the inner body includes:
a connection flange connected to the raw water discharge pipe and including a raw water outlet hole formed at a center of the bottom surface, through which the filtered and purified raw water flows out;
a raw water purification part formed on an inner surface of the inner body, through which the filtered and purified raw water flows in, and guiding the inflowing raw water to move upward toward the raw water outlet hole; and
a plurality of ceramic balls provided in the raw water purification part and providing an oriental medicine therapy or aroma therapy functions to the raw water.

5. The capsule type bidet filter according to claim 4, wherein the inner body further includes a filtration filter coupled to a lower end of the raw water purification part, filtering and purifying the raw water supplied to the outer body, and introducing the filtered and purified raw water into the raw water purification part.

6. The capsule type bidet filter according to claim 4, wherein the inner body further includes a filtration filter coupled to an outer circumferential surface, filtering and purifying the raw water supplied to the outer body, and introducing the filtered and purified raw water into the raw water purification part.

7. The capsule type bidet filter according to claim 1, wherein the outer body further includes an opening and closing member rotatably coupled to and opening and closing the open lower end.

8. The capsule type bidet filter according to claim 4, wherein the inner body further includes an inner cap detachably coupled to the open lower surface of the inner body and including a plurality of inlet holes formed to allow the supplied raw water to flow into the inner body.

9. The capsule type bidet filter according to claim 8, wherein the inner body further includes a filtration filter coupled to either the lower surface or an outer circumferential surface and filtering and purifying the supplied raw water.

10. The capsule type bidet filter according to claim 5, wherein the inner body further includes:
a filter fixing part bent from a lower end toward a center and supporting fixation and separation of the filtration filter; and
a support rib formed at a lower end of the filter fixing part and spaced away by a predetermined distance along a circumferential surface based on a center of the inner body, and to which the finishing member is joined.

11. The capsule type bidet filter according to claim 1, wherein the capsule type bidet filter is configured to be coupled inside a bidet controller so that the capsule type bidet filter is not exposed to outside.
